(19) United States
(12) Patent Application Publication
(10) Pub. No.: US 2003/0098958 A1
(43) Pub. Date: May 29, 2003

(54) Large screen projection device

(76) Inventors: Gunther Peschke, Mering (DE); Christoph Dobler, Seefeld (DE)

Correspondence Address: NIXON PEABODY, LLP, 8180 GREENSBORO DRIVE, SUITE 800, MCLEAN, VA, 22102, US

(21) Appl. No.: 10/026,169

(22) Filed: Dec. 27, 2001

(30) Foreign Application Priority Data
Nov. 27, 2001 (EP) 01 128 148.2

(51) Int. Cl. G03B 21/26

(52) U.S. Cl. 353/94

(57) ABSTRACT

A device for large screen projection with a projection lamp (1), an image projection plane (3) and an objective lens (5), the projection lamp (1) directing a cone (7) of light through the image projection plane (3) and through the objective lens (5) and a projection lamp. To greatly increase the light output of such a device and such a projection lamp, it is provided that the projection lamp (1) contains two light sources (2, 4) which are arranged relative to one another such that the envelopes (6, 8) of the two partial cones (10, 12) of light which are produced by the light sources (2, 4) and which feed a main cone of light (7) have at least one common envelope line (14).

### BACKGROUND OF THE INVENTION

1. Field of the Invention

This invention relates to a device for large screen projection, with a projection lamp, an image projection plane and an objective lens, the projection lamp directing a cone of light through the image projection plane and through the objective lens. The invention furthermore relates to a projection lamp for the lamp housing of a large screen projector.

2. Description of Related Art

A device of the initially mentioned type is part of a large screen projector for movie theaters, training centers, and similar installations and is usually called a “lamp housing” in technical language. The heart of this lamp housing is the projection lamp which is usually a high pressure xenon lamp, due to the high radiant efficiency and the very good color reproduction properties. This is conventionally defined as a high pressure lamp with a glass bulb filled with the rare gas xenon at a high pressure of more than 100 kPa. In projection lamps, xenon is preferred as the filler gas to mercury and sodium vapor to the extent that xenon in the arc, in addition to lines, emits a very intense continuum which in its spectral distribution is similar to daylight, and the light itself, as stated, has very good color reproduction properties. In addition to the glass bulb, the projection lamp also conventionally includes a shell-like reflector in which the glass bulb, aligned according to its optical axis, is held projecting at least partially over the edge of the reflector shell. This reflector reflects the light emitted from the arc in a (round) cone of light, the projection lamp being arranged such that it directs the cone of light through the rectangular image projection plane with the film strip running through there and through the objective lens. The latter is a projection objective lens which is optimized to large screen technology, and thus, is not comparable to an objective lens for ordinary video projection. Therefore, only a truncated pyramid which is rectangular in cross section is used from the cone of light which is circular in cross section.

One disadvantage of the xenon lamps which are preferred due to the radiant efficiency and color fidelity consists in that, in currently known materials and based on the geometrical configuration (for example, distance of the arc from the reflector) which has been established for known reasons (among others, the temperature load capacity), they have a maximum power of 10,000 W. A power beyond this can only be achieved with cooling; this makes the lamp larger, and thus, more difficult to handle. This maximum power is too little for one design or another of a large screen projection envelope. The trend is toward larger and larger projection areas; this can be recognized, for example, in that each new theater is laid out in the meantime as a “wide screen” theater. For this reason, to illuminate larger and larger image projection areas, therefore, for example, larger and larger movie screens, it is in no way sufficient to simply increase the distance of the projection lamp from the screen; on the one hand, the illuminance of an envelope decreases due to the photometric inverse-square law with the square of its distance from the light source. Thus, the power of the projection lamp when its distance from the projection envelope increases would have to be increased by the square of the increase in distance in order to obtain the same light intensity as before in the projection envelope. This is not possible with current xenon lamps which are limited to 10,000 W. On the other hand, the trend is also toward shorter and shorter theaters with wider and wider image projection areas. The short focal lengths of the projector dictated thereby physically cause a drop of the light intensity to the edge; this leads to unsatisfactory illumination of the image.

At this point, it is known from 3D technology that two of these known xenon projection lamps next to one another can be used. FIG. 1 shows one such arrangement which belongs to the prior art. It consists of two projection lamps 1, 1′, each with a shell-shaped reflector 20, 22 in which—aligned according to their optical axes 16, 18—there is a respective glass bulb 23, 25 which forms the actual light sources 2, 4. Each of these projection lamps 1, 1′ directs a partial cone of light 10, 12 through a first prism arrangement 9, 11 which supplies the partial cones of light 10, 12—each separately and not combined into a common cone of light—to a second prism arrangement 13, 15. Afterwards the partial cones 10, 12 of light pass through the image projection plane 3 and are thrown onto the projection envelope, therefore, for example, a movie screen, by the 3D objective lens 5, in turn, individually and not combined. In this arrangement, the prism arrangements 9, 11 and 13, 15 are used for gradual deflection of the partial cones 10, 12 of light, which as a result of the distance of the projection lamps 1, 1′ from one another, which distance is dictated by the reflectors 20, 22, without the two prism arrangements 9, 11; 13, 15, would strike the image projection plan 3 and especially the objective lens 5 at an overly large angle. Any deflection of the partial cone 10, 12 of light by the prism arrangements 9, 11; 13, 15, of course, is accompanied by a considerable loss of light intensity and color fidelity which must be tolerated in 3D applications. However, it would be desirable here to increase the power of the two projection lamps 1, 1′ which is limited to 10,000 W, since, in this way, an increase of the image projection area would be possible.

### SUMMARY OF THE INVENTION

A primary object of the invention is to develop a device for large screen projection with a projection lamp which directs a cone of light through an image projection plane and an objective lens such that a clear power increase of the projection lamp can be achieved.

This object is achieved in a device for large screen projection and by a projection lamp for the lamp housing of a large screen projector of the initially described types in that the projection lamp contains two light sources which are arranged relative to one another such that the envelope of the two partial cones of light which are produced by the light sources, and which feed the (main) cone of light, have at least one common envelope line.

The approach in accordance with the invention—it is the same in the device for large screen projection as in the projection lamp for the lamp housing of a large screen projector—exploits the fact that the reflector of a projection lamp, in the upper edge area of the reflector shell, reflects only the scattered light which supplied the truncated pyramid-shaped cone of light which can be used for image projection, not at all or only negligibly. The cone of light, based on the given geometrical configuration of a projection lamp, of course, independently of the curvature of the reflector shell, is produced anyway only in a limited inner area of the reflector shell. According to the invention, the device for large screen projection or the projection lamp for the lamp housing of a large screen projector, therefore, contains two light sources, for example, in the form of two conventional xenon high pressure lamps which are arranged relative to one another such that the envelopes of the two individual partial cones of light which are produced by the two light sources are so close to one another that the two partial cones of light have at least one common envelope line. Here, the designations “envelope of the cone” and “envelope line,” terms take from stereometry for describing a cone, are therefore used also to describe the relative position of the two partial cones of light with respect to one another. It is an important element of this invention that the partial cones of the light which are formed by the useful reflected light are so close to one another such that they pass through the image projection plane with the image carrier which passes there as a common (main) cone of light and also penetrate the objective lens as a cone of light. While parallelism of the optical axes of the two light sources due to the geometrical configuration of the light sources, on the one hand, and of the reflectors, on the other, may not be attainable, still an angle as acute as possible between the two optical axes is desirable in order to illuminate the image projection plane (in large format, i.e., with 70 mm film, 36×48 mm) adequately and to direct the produced light as much as possible without losses through the objective lens.

The advantages of the approach in accordance with the invention, on the one hand, lie in a light output roughly 60% higher as compared to the use of a single conventional projection lamp, and on the other hand, in the possibility which accompanies this higher output of being able to illuminate very large image projection envelopes, such as movie screens or the like, with an outstanding light intensity and color intensity.

Advantageous developments of the invention which apply both to the device for large screen projection and also to the projection lamp for the lamp housing of a large screen projector are described in greater detail below.

Thus, it is provided, for example, that the optical axes of the two partial cones of light are arranged at an angle of roughly 18° with respect to each other. This value was found by studies of the light distribution on the image projection area using the approach according to the invention.

It was explained above that the invention, among others, exploits the fact that the cone of light is produced only by one part of the inner reflector shell. This finding is also used to make the two light sources in accordance with the invention with their reflectors such that the two reflectors pass into one another on the common envelope line of the partial cones of light, then the common center line in cross section defining the plane of section of the two reflectors with one another.

This transition of one (partial) reflector into the other is accomplished preferably by the edges of each of the partial reflectors assigned to the two light sources each being shortened on the side facing one another and the shortened sections being joined to one another. This yields, in turn, a common edge line which defines in cross section a plane of section of the two reflectors with one another.

One preferred embodiment of the invention is explained in detail using the accompanying drawings.

### BRIEF DESCRIPTION OF THE DRAWINGS

FIG. 1 is schematic cross-sectional view of a prior art 3D projection arrangement;

FIG. 2 is schematic cross-sectional view of a device for large-screen projection or a projection lamp for the lamp housing of a large screen projector in accordance with the present invention;

FIG. 3A & 3B are light intensity and light area distribution diagrams, respectively, of a light distribution in accordance with the invention;

FIG. 4A & 4B are light intensity and light area distribution diagrams, respectively, of a 35 mm film light distribution at the image plane at the image plane; and

FIG. 5A & 5B are light intensity and light area distribution diagrams, respectively, of a 70 mm film light distribution at the image plane.

### DETAILED DESCRIPTION OF THE INVENTION

The 3D lamp housing as in the prior art was already explained in the introduction. It contains two projection lamps 1, 1′ in the form of commercial high pressure xenon lamps which each produce a partial cone 10, 12 of light. These partial cones 10, 12 of light are directed separately through prism arrangements 9, 11; 13, 15 and afterwards through an image projection plane 3 and a 3D objective lens 5. However, in spite of the use of two projection lamps 1, 1′ with a maximum 10,000 W power each, light intensity and color intensity cannot be increased beyond the values which can be attained with a single projection lamp. Such a double lamp arrangement is not built for purposes of increasing the power, but simply to be able to project the two images necessary for 3D projection at the same time.

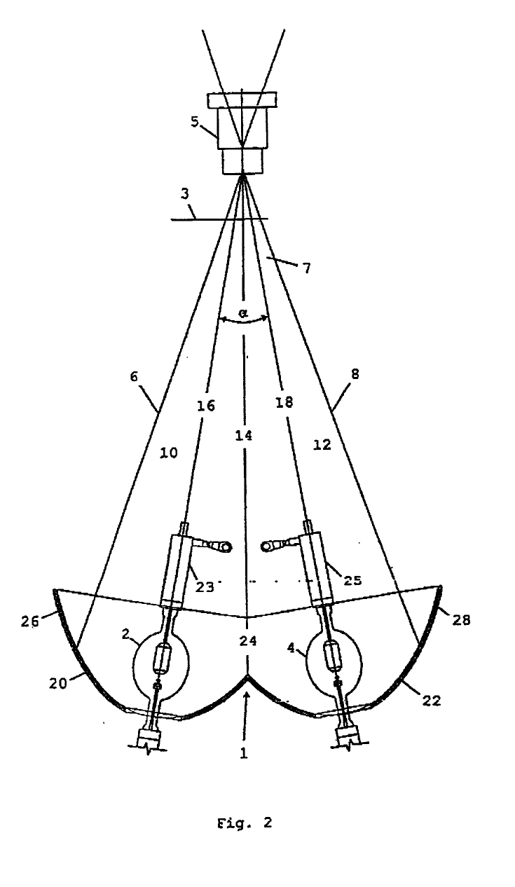

FIG. 2 shows a device in accordance with the invention for large screen projection and a projection lamp for the lamp housing of a large screen projector in cross section. The entire device shown, which is also called a “lamp housing” among specialists, contains essentially a projection lamp 1, an image projection plane 3 and an objective lens 5, the projection lamp 1 directing a cone 7 of light through the image projection plane 3 and through the objective lens 5. The projection lamp 1 contains two light sources 2, 4, such as commercially produced high pressure xenon lamps. In these lamps, the light is produced by an arc which is formed in a glass bulb 23, 25 which is filled with xenon gas at a relatively high pressure of more than 100 kPa. A respective reflector 20, 22 is assigned to each of the light sources 2, 4 and they differ from the reflectors of commercial projection lamps in that the edge areas 26, 28 of these reflectors are each shortened on the side facing one another and these shortened sections are connected to one another. The two light sources 2, 4 with their reflectors 20, 22 are positioned relative to one another such that the optical axes 16, 18 of the two reflectors 20, 22 include an angle α of roughly 18°.

The partial cones 10, 12 of light emitted by the light sources 2, 4 by means of the reflectors 20, 22 form that part of the light from the light source 2, 4 which is reflected entirely by the reflectors 20, 22 and which is also used for image projection. This portion of the total light is produced only within an area of the shell-like reflectors 20, 22 which does not include the edge area 26 and 28 at the same time. The portion of the light reflected by these edge areas 26, 28 is specifically scattered light which does not contribute to image projection.

As is apparent from the sectional view in FIG. 2, the two partial cones 10, 12 of light are so close to one another that the envelopes of 6, 8 those partial cones 10, 12 of light which are produced by the light sources 2, 4 and which feed the (main) cone 7 of light have a common envelope line 14 in the middle between the two partial cones 10, 12 of light. This common envelope line 14 also defines a plane 24 of section of the two reflectors 20, 22 on which the reflectors 20, 22 pass into one another in the center. This was achieved in this embodiment by the edge areas 26, 28 of the reflectors 20, 22 which contribute nothing to the useful partial cones 10, 12 of light each being shortened on that plane of section 24, therefore on the sides facing one another, and the shortened sections being joined to one another.

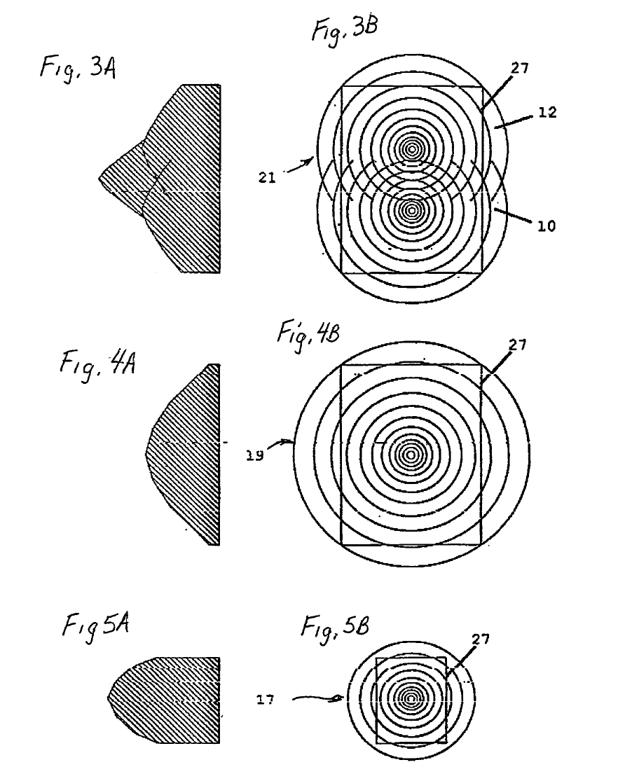

FIGS. 3A, 3B to 5A, 5B shows three light distribution diagrams 17, 19, 21, in the image projection plane, light distribution diagram 21 being at the image plane 3 in FIG. 2. Using these three light distribution diagrams of FIGS. 3A, 3B to 5A, 5B, the initially described problem of inadequate illumination of large image projection areas 27, for example, a movie screen, based in part on the short focal lengths in modem wide screen theaters and partially on the photometric inverse-square law, with uniform light output becomes clear. FIG. 3B shows the image projection areas 27 which can be illuminated, of course, into the comers with projected light, and FIG. 3A is a diagram of the corresponding light intensity distribution with uniform power of the light source. FIGS. 5A, 5B show light distribution diagrams corresponding to those of FIGS. 3A, 3B, but for a image projection 17 of normal size (35 mm film with an image projection plane of 18×24 mm) in which the image projection area is designated 27′. Similarly, FIGS. 4A, 4B, show an image projection area 27 of a light distribution 19 which is quadrupled in size (large image of 70 mm film with an image projection plane of 36×48 mm) and in addition the distribution of the light intensity with uniform power of the light source. The clear flattening of the light intensity curve shows a still relatively high, but, as compared to the example of light distribution 17, clearly reduced light intensity in the center of the area 27, while in the edge areas much lower light intensities can be measured from the start. This highly reduced illuminance of the image projection area 27 is due essentially to the aforementioned photometric inverse-square law and the short focal lengths.

Finally, light distribution diagram 21 shows the result which can be attained with the device for large screen projection and the projection lamp in accordance with the present invention. The image projection envelope 27 compared to the example of the light distribution 19 is unchanged, and here too the entire image projection envelope into the comers is encompassed by the two partial cones of light. The light distribution diagram 21 in FIGS. 3A, 3B show a light and light intensity distribution which is greatly improved relative to the light distribution 19 and which is based on the fact that the cone of light resulting from the two partial cones 10, 12 of light intensifies towards the center of the image and the individual partial cones 10, 12 of light are nearer the right and left image edge than in the single cone of light according to light distributions 17 and 19.

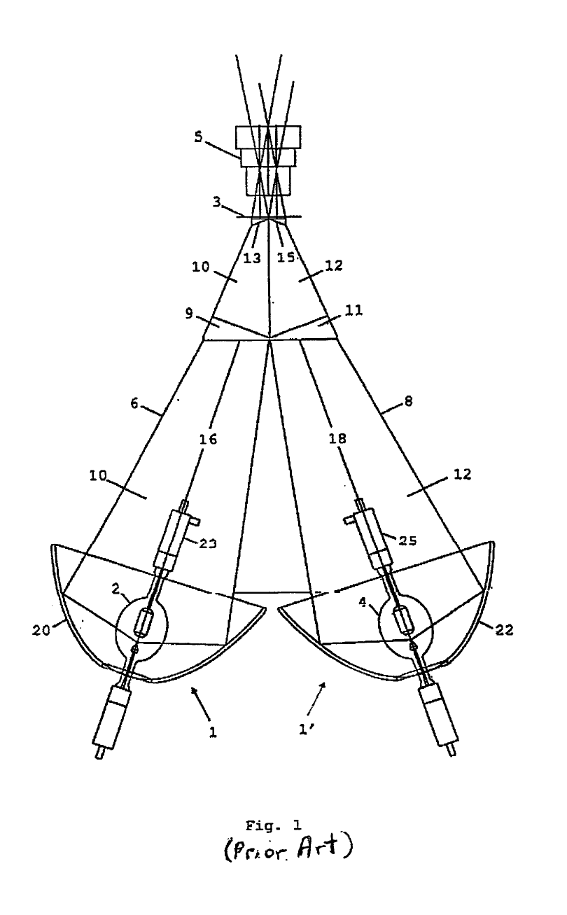

The double lamp arrangement in accordance with the invention can, of course, also be applied to 3D applications as shown in FIG. 1, and then, each of the individual projection lamps could be replaced by the double lamp arrangement of this invention. The larger angle of incidence which occurs here could also be balanced by the corresponding configuration of the prism arrangements.

What is claimed is:

1. Device for large screen projection, comprising:
a projection lamp;
an image projection plane; and
an objective lens;
wherein the projection lamp contains two light sources which are arranged relative to one another in a manner adapted to produce light envelopes in the form of a partial cone of light from each of the light sources that is directed through the image projection plane and through the objective lens; and wherein a main cone of light is formed from said light sources about a common envelope line of said two partial cones of light.

2. Device as claimed in claim 1, wherein the two partial cones of light have optical axes arranged at an included angle of roughly 18°.

3. Device as claimed in claim 2, further comprising a reflector associated with each of the two light sources, the reflectors defining parabolic shapes which intersect at a junction line of the reflectors which extends in a plane containing said common envelope line of the partial cones of light.

4. Device as claimed in claim 1, further comprising a reflector associated with each of the two light sources, the reflectors defining parabolic shapes which intersect at a junction line of the reflectors which extends in a plane containing said common envelope line of the partial cones of light.

5. Device as claimed in claim 3, wherein edge areas of the reflectors are each shortened on facing side facing thereof, said shortened edge areas being connected to one another.

6. Device as claimed in claim 1, wherein edge areas of the reflectors are shortened on facing sides thereof, said shortened edge areas being connected to one another.

7. Projection lamp for a lamp housing of a large, screen projector, comprising:
two light sources which are arranged relative to one another in a manner adapted to produce light envelopes in the form of a partial cone of light from each of the light sources; and
wherein a main cone of light is formed from said light sources about a common envelope line of said two partial cones of light.

8. Projection lamp as claimed in claim 7, wherein the two partial cones of light have optical axes arranged at an included angle of roughly 18°.

9. Projection lamp as claimed in claim 8, further comprising a reflector associated with each of the two light sources, the reflectors defining parabolic shapes which intersect at a junction line of the reflectors which extends in a plane containing said common envelope line of the partial cones of light.

10. Projection lamp as claimed in claim 7, further comprising a reflector associated with each of the two light sources, the reflectors defining parabolic shapes which intersect at a junction line of the reflectors which extends in a plane containing said common envelope line of the partial cones of light.

11. Device as claimed in claim 9, wherein edge areas of the reflectors are each shortened on facing side facing thereof, said shortened edge areas being connected to one another.

12. Device as claimed in claim 7, wherein edge areas of the reflectors are shortened on facing sides thereof said shortened edge areas being connected to one another.
